(19) United States
(12) Patent Application Publication
(10) Pub. No.: US 2002/0119723 A1
(43) Pub. Date: Aug. 29, 2002

(54) Filter material for separating solid, particulate and gaseous substances from fluids

(76) Inventors: Peter Heinrich, Duisburg (DE); Stefan Kaemper, Ratingen (DE); Gerald Rosenberg, Erkrath (DE); Stefan Weiss, Duesseldorf (DE); Jost Kames, Duesseldorf (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/066,804

(22) Filed: Feb. 6, 2002

Related U.S. Application Data
(63) Continuation of application No. PCT/DE00/02512, filed on Jul. 29, 2000.

(30) Foreign Application Priority Data
Aug. 6, 1999 (DE) 199 36 743.4

(51) Int. Cl. D04H 1/00; D04H 3/00; D04H 5/00; D04H 13/00; B32B 5/18; B32B 5/24; B32B 27/02; B32B 5/16

(52) U.S. Cl. 442/389; 442/340; 442/346; 442/351; 442/370; 442/373; 442/381; 442/392; 442/393; 442/414; 442/415; 442/417

(57) ABSTRACT

A filter material for separating solid, particulate and gaseous components from fluids, which is enclosed on both the upstream and downstream sides with a particle filtering medium.

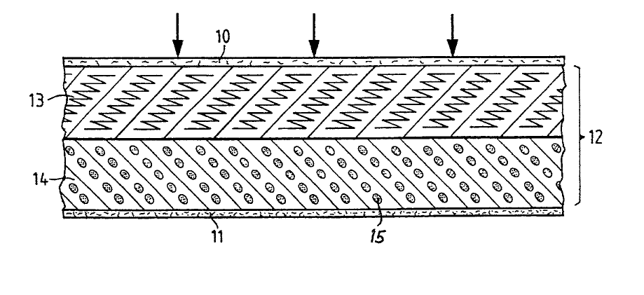

### CROSS REFERENCE TO RELATED APPLICATIONS

This application is a continuation of international patent application no. PCT/DE00/02512, filed Jul. 29, 2000, designating the United States of America, the entire disclosure of which is incorporated herein by reference. Priority is claimed based on Federal Republic of Germany patent application no. DE 199 36 743.4, filed Aug. 6, 1999.

### BACKGROUND OF THE INVENTION

The invention relates to a filter material for separating solid, particulate and gaseous contaminant substances from fluids.

Boettger et al., U.S. Pat. No. 6,083,856 (=EP 802,997) discloses a flat element with an air permeable medium. This element serves to filter out odorous substances and is used, for instance, in seats, shoes, home textiles, clothing, etc. It can optimally absorb moisture or transport it away from the respective moisture source to provide good climatic comfort. A drawback in this system is that it requires a multi-layer structure with a felt layer. This felt layer must be joined to the adsorption element by appropriate needling.

Bluecher et al., U.S. Pat. No. 4,510,193 (=DE 33 04 349) further discloses a flat filter with adsorbents fixed thereto, as well as a process for its production. To fix the adsorbents, which consist particularly of activated carbon, the support material is provided with an adhesive or with adhesive spots. The support material is, for example, a textile support structure, while the adhesive is a solvent-free polyurethane. This type of flat filter is especially used in industry but also in the household and for protective clothing. A drawback of this known flat filter is that the adsorbents remove only certain components from the fluid. A filtration of the fluid flowing through it that will remove both gaseous and solid or particulate components is not possible with this filter type.

### SUMMARY OF THE INVENTION

It is an object of the invention to provide a filter material which obviates the aforementioned drawbacks of prior filter materials.

Another object of the invention is to provide a filtering material which is suitable for removing the principal harmful components from fluids.

A specific object of the invention is to provide a filtering material which is particularly suitable for filtering the ventilation air for the passenger compartment of a motor vehicle.

These and other objects are achieved by the present invention by providing a filtering material for separating solid, particulate and gaseous materials from a fluid, the filtering material comprising a first particle filtering medium made of a nonwoven web on an inflow side of the filtering material; a second particle filtering medium made of a nonwoven web on a discharge side of the filtering material; an adsorbent layer of an electret material between the first and second particle filtering media, and an air-permeable foam layer containing at least one adsorptive, chemisorptive or catalytically active substance.

The filtering material of the invention makes use of a particle filtering medium on both the inflow side and the discharge side of the material. The invention has the advantage that a three-layer filter material is constructed and that the center layer contains certain materials that have an adsorptive, chemisorptive or catalytic effect. Such materials include, for example, activated carbon or other substances that are arranged on a support structure. The outer layers, which are arranged on the inflow and the discharge side, respectively, act as stabilizers of the inner layer and thus have the function of embedding or enclosing these materials. At the same time, they also perform a filtering function.

According to one embodiment of the invention, the particle filtering media are made of a non-woven material. It is of course also possible to use filter paper. The non-woven or paper materials can be constructed identically on the inflow and the outflow side. It is also possible to combine different materials, for instance a nonwoven material and a paper material, to realize step-wise filtration.

In a preferred embodiment of the invention, the nonwoven layers comprise fiber mixtures of two or more polymers selected from the group consisting of polypropylene, polycarbonate, polyester, polyamide, polyterephthalate or combinations thereof. The use of these materials has the advantage that it allows for simple thermal disposal of used filter materials by incineration. The adsorptive, chemisorptive or catalytically active substances that are embedded between the two nonwoven or paper layers may be selected, for example, from the group consisting of activated carbon, silica gels, zeolites, polymeric ion exchangers, aerogels, alumina or mixtures of these materials. An optimal combination of the filter materials to separate solid, particulate or gaseous components can be achieved as a function of the application.

Another embodiment of the invention provides for folding the filter material in a zigzag fashion and disposing it in a filter cassette. It is of course also possible to provide flat filters having this construction, for example, for use in air conditioning systems.

Composite materials comprised of nonwoven supports, adsorbents and particle filters are used in a wide variety of applications for the conditioning of air. In the production process, the amount of adsorbent is applied to an air-permeable nonwoven support fabric and fixed in place with adhesive, and the inflow side is covered with a particle-filtering nonwoven medium. In this composite, only the adsorbent layer and the cover layer have the function of removing gases and particles from the medium, e.g., air. The support layer has no such function. To obtain the greatest possible particle separation efficiency, the cover layer must have fine fibers, which comes at the expense of air permeability of the entire material. The resulting pressure loss across a filter element constructed in this way is correspondingly high.

The invention is implemented, for instance, by using an air permeable but particle-filtering material that is made of very fine fibers both as the support and as the cover layer in the medium. The filter efficiency of each layer can be lower than that of the particle filter layer of the media used in the prior art. Dual filtration provides the required filter efficiency. No impairment of adsorptive filtration is observed. Due to the homogenous structure, high air permeability is achieved. Economic advantages are obtained by eliminating the one type of nonwoven material that acts only as a support and does not contribute to filtering. Any release of abraded adsorbent particles or dust is furthermore effectively prevented.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWING

The invention will now be described in greater detail with reference to an illustrative preferred embodiment shown in the accompanying drawing FIGURE.

### DETAILED DESCRIPTION OF PREFERRED EMBODIMENTS

The drawing FIGURE illustrates the structure of a filter material in a multi-layer arrangement. The filter material shown in the FIGURE is suitable, e.g., for use in an air conditioning system or for the ventilation of the interior of a motor vehicle. It comprises a first layer of a nonwoven material 10, a second layer of a nonwoven material 11 and an adsorber filter 12 arranged therebetween. The first and second particle filtering media may be identical, or a different, e.g. a finer, particle filtering medium may be used on the discharge side. The particle filtering media advantageously may be present in an amount of from 100 to 900 g/m², preferably 400 to 605 g/m². The adsorber filter 12 in this example consists of an electret material 13, e.g., in the form of polycarbonate or polypropylene microfibers. The particles are retained in this layer of electret material 13 by electrostatic forces. The additional layer in this example consists of a catalytically effective material 15, such as activated carbon. The activated carbon is added to a foam support, particularly an air-permeable foam mat 14. A solvent-free polyurethane is used to bond the activated carbon to the foam mat. Using polyurethane as the adhesive has the advantage that the adhesive layer enhances the stability of the foam mat.

The nonwoven materials 10, 11 are effective particle filtering layers, that is to say, the fluid flowing through the filter element, e.g., air, is initially purified on the nonwoven material 10. Additional particles and odorous substances are adsorbed by layers 13 and 14. The remaining particles are deposited on the inside of the nonwoven material 11. With the structure shown here, it is possible to provide the nonwoven material layer 10 with relatively low flow resistance, i.e., with high porosity. As a result, although a portion of the entrained particles flows into the filter element, these particles are deposited on the inside of the nonwoven material 11 due to the greater filter fineness of the nonwoven material 11. This has the advantage that especially the small and easily suspended particles are captured in the filter system, and any accidental release of these dust particles due to shocks or vibrations is prevented.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A filtering material for separating solid, particulate and gaseous materials from a fluid, said filtering material comprising a first particle filtering medium made of a nonwoven web on an inflow side of said filtering material; a second particle filtering medium made of a nonwoven web on a discharge side of said filtering material; an adsorbent layer of an electret material between said first and second particle filtering media, and an air-permeable foam layer containing at least one adsorptive, chemisorptive or catalytically effective substance.

2. A filter material according to claim 1, wherein the at least one adsorptive, chemisorptive or catalytically effective substance comprises activated carbon.

3. A filtering material according to claim 1, wherein said electret material comprises polycarbonate or polypropylene microfibers.

4. A filtering material according to claim 1, wherein said first and second particle filtering media are identical.

5. A filtering material according to claim 1, wherein said first and second particle filtering media are made of fibers of at least one polymer selected from the group consisting of polypropylene, polycarbonate, polyester, polyamide and polyterephthalate.

6. A filtering material according to claim 5, wherein said first and second particle filtering media are each made of a combination of at least two polymers selected from said group.

7. A filtering material according to claim 1, wherein the at least one adsorptive, chemisorptive or catalytically effective substance is selected from the group consisting of activated carbon, silica gels, zeolites, polymeric ion exchangers, aerogels and alumina.

8. A filtering material according to claim 7, comprising a mixture of at least two substances selected from said group.

9. A filtering material according to claim 1, wherein the particle filtering media is present in an amount of from 100 to 900 g/m².

10. A filtering material according to claim 9, wherein the particle filtering media is present in an amount of from 400 to 605 g/m².

11. A filtering material according to claim 1, wherein said material is folded in zig-zag form and installed in a filter cassette.

12. A filtering material according to claim 1, wherein the electret material consists of polycarbonate or polypropylene microfibers.
